(19) United States
(12) Patent Application Publication
(10) Pub. No.: US 2010/0250283 A1
(43) Pub. Date: Sep. 30, 2010

(54) SYSTEM AND METHOD FOR GENERATING CUSTOM EXERCISE PROGRAMS

(76) Inventors: Thomas G. Winter, Tucson, AZ (US); Grant R. Winter, Lancashire (GB)

Correspondence Address: HAYES SOLOWAY P.C., 3450 E. SUNRISE DRIVE, SUITE 140, TUCSON, AZ, 85718, US

(21) Appl. No.: 12/746,139

(22) PCT Filed: Dec. 11, 2008
(86) PCT No.: PCT/US08/86465

§ 371 Date: Jun. 3, 2010

Related U.S. Application Data
(60) Provisional application No. 61/013,910, filed on Dec. 14, 2007.

(51) Int. Cl. G06Q 50/00; A63B 71/00

(52) U.S. Cl. 705/3; 705/2; 482/9; 482/8

(57) ABSTRACT

The system contains a programmable device. A first code stored on the programmable device tracks time on the programmable medium. A second code stored on the programmable device provides reminders to a user to perform rehabilitative exercises at intervals measured by the first code. A third code stored on the programmable device tracks exercises performed.

The present invention relates generally to systems and methods for providing custom programs. The invention has particular utility in the production of personalized exercise and physical rehabilitation programs on machine-readable media such as DVDs, and will be described in connection with such utility although other utilities including, but not limited to broadcasting or delivery of the program through the internet, are contemplated.

Exercise and rehabilitation programs are recommended by chiropractors, osteopaths, physiotherapists and exercise instructors. Typically such programs include exercises which are demonstrated briefly during a session with a patient or client and may be accompanied by written and/or diagrammatic exercise sheets. While a patient or a client may meet periodically with his chiropractor, osteopath, physiotherapist and exercise instructor, the patient or client is left to his or her own memory. Since it is important that exercises be properly done, both from the standpoint of therapy results, and also to avoid further injury to the body, a need exists for providing a patient or client with a personalized instructional program tailored to the individual's needs.

Briefly described, the present invention includes a programmable device for creating and storing personalized or customized instructional exercise programs. In a preferred embodiment of the invention a first code stored on the programmable device tracks time on the programmable device; a second code stored on the programmable device provides reminders to a user to perform rehabilitative exercises at intervals measured by the first code, and a third code stored on the programmable device tracks exercises performed.

The present invention can also be viewed as providing methods for creating personalized or customized rehabilitation exercises. In a preferred embodiment of the invention the method includes creating a personalized exercise program; providing reminders to a user to perform rehabilitative exercises at intervals according to tracked time; and tracking exercises performed.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

Many aspects of the invention can be better understood with reference to the accompanying drawings wherein like numerals depict like parts, and wherein:

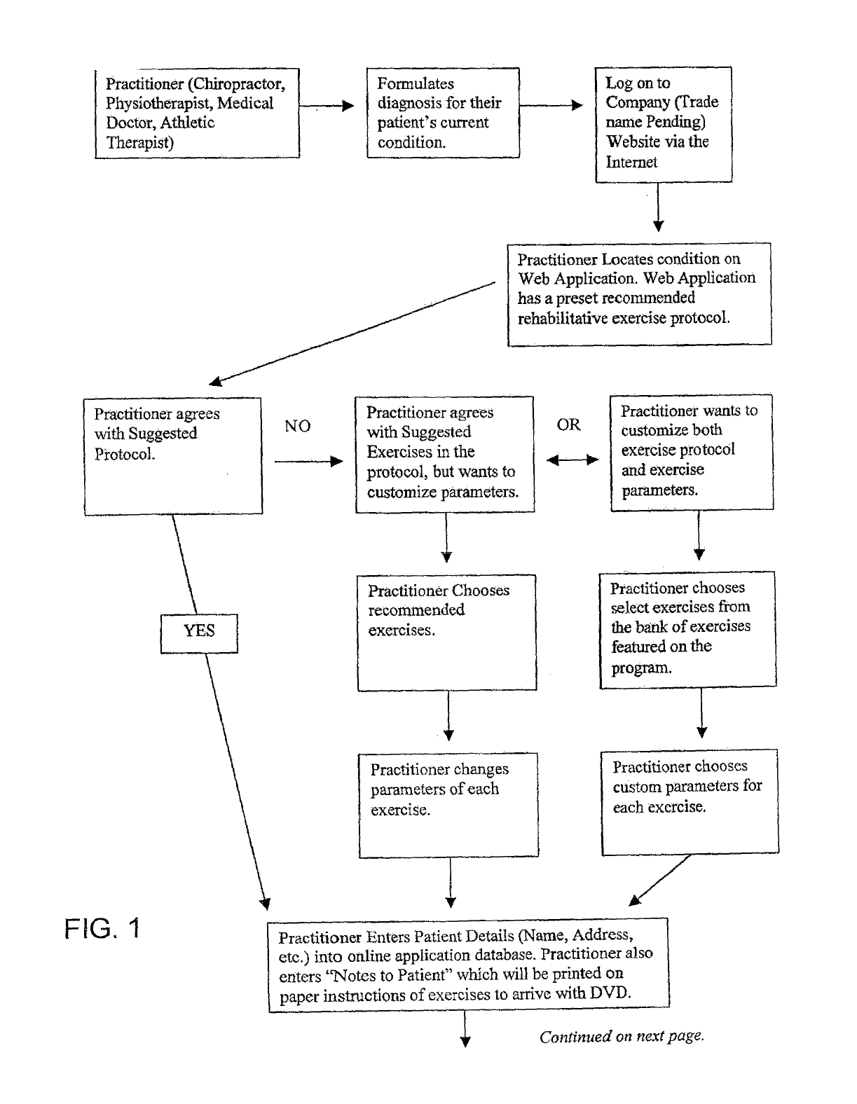

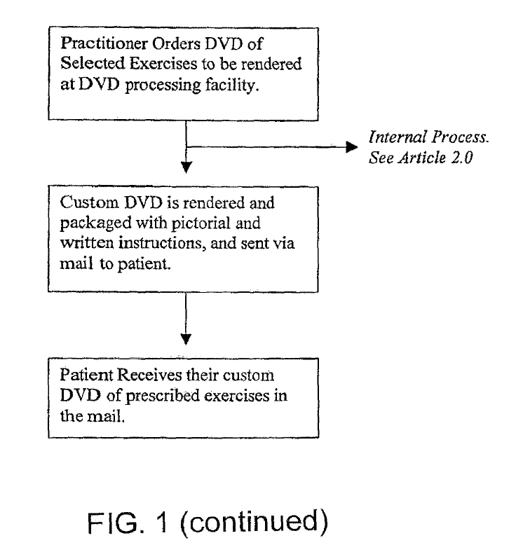

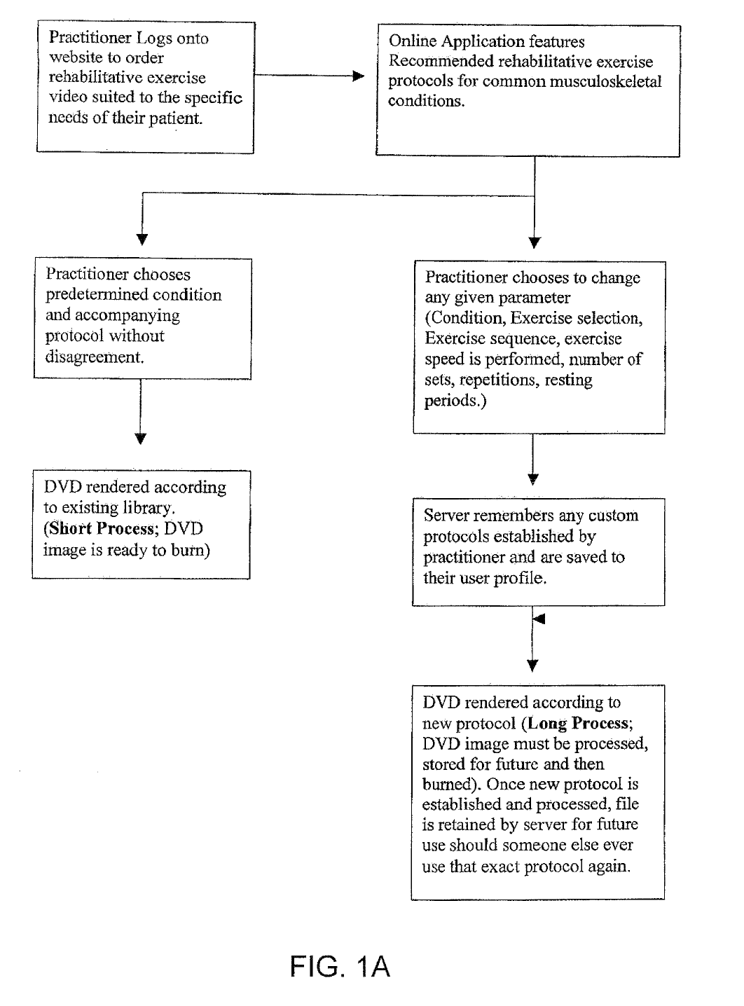

FIGS. 1, 1A and 1B are block diagrams illustrating a system for creating a personalized or customized exercise program in accordance with the present invention;

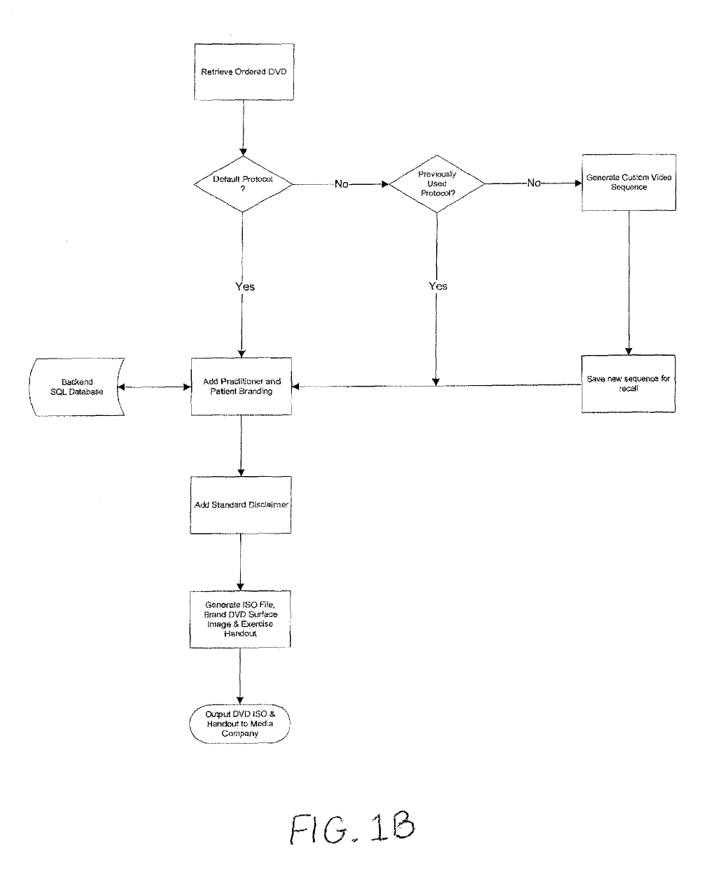

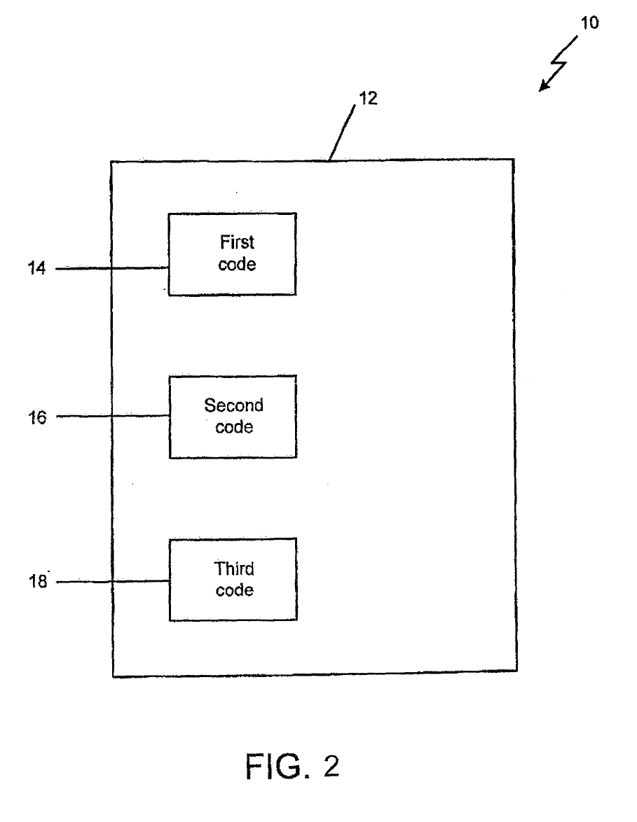

FIG. 2 is a block diagram illustrating a system for rehabilitation, in accordance with a first exemplary embodiment of the present invention;

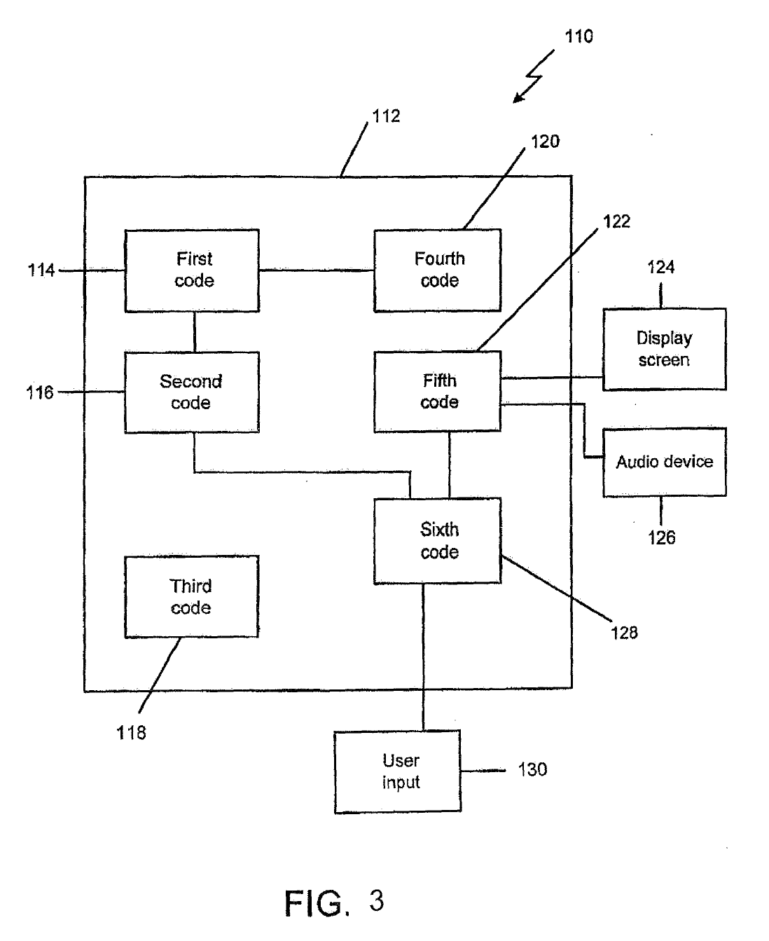

FIG. 3 is a block diagram illustrating a system for rehabilitation, in accordance with a second exemplary embodiment of the present invention; and

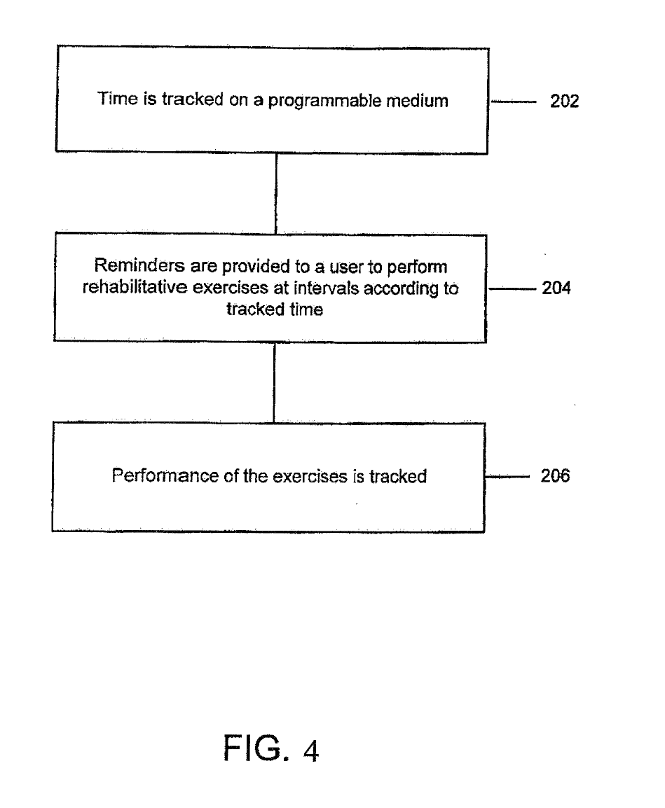

FIG. 4 is a flowchart illustrating a method for overseeing performance of rehabilitative exercises, in accordance with the first exemplary embodiment of the present invention.

Referring first to FIGS. 1, 1A and 1B, in order to create a personalized or customized rehabilitation exercise program for a patient, a practitioner will examine a patient and formulate diagnosis for the patient's condition. The practitioner then logs onto the company's website via the Internet, and locates conditions from a pull down menu. The web application will have a preset recommended rehabilitation exercise program. If the practitioner agrees with the suggested exercise program or protocol, the practitioner enters the patient's details and creates a customized program for the patient. The customized program can be loaded onto a DVD and shipped to the patient together with written instructions, or the program may be made accessible to the patient via the Web.

If on the other hand, the practitioner agrees with the suggested exercises, but wishes to customize parameters, the practitioner may then customize parameters either from a further pull down menu, or the practitioner may write on the program. Alternatively, if the practitioner wishes to customize both protocol and exercise parameters, the practitioner may select exercises from a library of exercises, and if desired, write customized parameters for each exercise. Once the standard protocol with customized parameters or custom protocol with customized parameters has been determined, the practitioner will then enter the patient's details, which then may be printed on a DVD or accessible directly to the patient via the Web.

Alternative methods for determining a customized package are illustrated in FIGS. 1A and 1B. As shown by FIG. 1A, the Web server recognize the identity of the practitioner, such as for example by the use of a login name and password, where the practitioner logs onto the website to order a rehabilitative exercise. The online application supplies recommended rehabilitative exercise protocols for the relevant patient conditions. The practitioner may then choose to accept the recommended protocols without disagreement, upon which a DVD is rendered according to the existing library. This is called a “short process”, because the DVD image is ready to burn. Alternatively, the practitioner may choose to change any given parameter, such as patient condition, exercise selection, exercise sequence, speed of exercise performance, number of sets, number of repetitions per set, frequency and duration of resting periods, or other parameter. The practitioner's choices are remembered and stored in the practitioner's profile. The DVD is then rendered according to a “long process”, wherein the new image is processed before burning to the DVD. This new image is then retained for future use by this or another practitioner.

FIG. 1B illustrates another alternative embodiment. In this instance, the practitioner chooses whether or not to use the default or recommended protocol. If the practitioner chooses not to use the default protocol, the practitioner may choose to use a previously generated protocol. The previously generated protocol may have been prompted by this or another practitioner. Otherwise, the practitioner may generate a further customized sequence which is then saved for recall. Other possible customizations include practitioner and patient branding and the inclusion of standard disclaimers (the practitioner may also add custom disclaimers). Each of the practitioner's choices may be stored in a database for convenience in future transactions.

FIG. 2 is a block diagram illustrating a system 10 for rehabilitation, in accordance with a first exemplary embodiment of the present invention. The system 10 includes a programmable device 12. A first code 14 stored on the programmable device 12 tracks time. A second code 16 stored on the programmable device 12 provides reminders to a user to perform rehabilitative exercises at time intervals as measured by the first code 14. A third code 18 stored on the programmable device 12 tracks exercises performed.

FIG. 3 is a block diagram illustrating a system 110 for rehabilitation, in accordance with a second exemplary embodiment of the present invention. The system 110 includes a programmable device 112. A first code 114 stored on the programmable device 112 tracks time. A second code 116 stored on the programmable device 112 provides reminders to a user to perform rehabilitative exercises at time intervals as measured by the first code 114. A third code 118 stored on the programmable device 112 tracks exercises performed.

The system 110 may also include a fourth code 120 on the programmable device 112 for tracking interaction between a user and the programmable device 112, wherein the second code 116 provides reminders at intervals of activity as measured cooperatively between the first code 114 and the fourth code 120. A purpose of the fourth code 120, for instance, would be to track if someone has been seated at a computer for an extended period of time and requires a given exercise to alleviate risk of developing repetitive strain injuries that may be associated with significant usage of the programmable device 112.

The fourth code 120 may also be useful for tracking performance of the rehabilitative exercises. Specifically, if a user is reminded to perform a rehabilitative exercise and indicates acceptance of the reminder, but continues to be active on the programmable device 112 when the rehabilitative exercise would make such activity impossible, the system 110 may register that the user has not performed the rehabilitative exercise. Similarly, if a rehabilitative exercise is to be performed for five minutes, but activity on the programmable device 112 ceases after only three minutes, the system 110 may register the noncompliance with the exercise reminder. Noncompliance may be tracked and reviewed by the user, a human resources representative and/or a physician, either locally to the programmable device 112 or from a remote location.

The system 110 may also include a fifth code 122 for demonstrating the rehabilitative exercises on a display screen 124, wherein the display screen 124 is in communication with the programmable device 112. The display screen 124 may be in wired or wireless communication with the programmable device 112. The demonstration may involve one or more figures explaining the rehabilitative exercise, one or more videos or animations showing the rehabilitative exercise, and/or audio explaining or encouraging the rehabilitative exercise. The audio may be provided through an audio device 126 in communication with the programmable device.

The system 110 may also include a sixth code 128 operative through a user input 130 for modifying the rehabilitative exercises to be performed and/or a size or frequency of the time intervals. A variety of rehabilitative exercises may be made available with the present invention, and some exercises may be useful for some, but not others. Thus, a user may be able to modify which exercises they are reminded to perform. Similarly, a human resources representative for a company, a physician, or the like may be able to make modifications to the exercises either on the programmable device 112 or through remote communication with the programmable device. The user input 130 may be a combination of a local input device and a receiver for receiving remote communications.

Further, it may be that the rehabilitative exercises are selected and applied to a DVD or similar media and run therefrom onto the programmable device 112. For instance, a physician, chiropractor, or other caregiver may download a collection of one or more rehabilitative exercises from a library of video clips of actual persons demonstrating specific exercises, or computer animations on an application site and provide them to a patient, either for operating on the programmable device 112 from a DVD or similar medium, or for saving to a hard drive of the programmable device 112. The exercise reminders may be provided through a cell phone, laptop, personal computer, personal digital assistant, or any other programmable device 112.

The application site may further provide manipulable exercises or physical activities that a physician, chiropractor, or other caregiver can download for a patient. Specifically, the application site may allow the physician, chiropractor, or other caregiver to define the exercises, the duration of the exercise, the pace of the exercise, the number of repetitions in the exercise, rest time during exercising, and the number of sets and rest time therebetween. The more customizable the exercise, the better served a user of the programmable device 112 may be when receiving the exercise material from the physician, chiropractor, or caregiver.

FIG. 4 is a flowchart 200 illustrating a method of overseeing performance of rehabilitative exercises in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 202, time is tracked on a programmable medium. Reminders are provided to a user to perform rehabilitative exercises at intervals according to tracked time (block 204). Performance of the exercises is tracked (block 206).

The method may include tracking interaction between a user and the computer readable medium. In this regard, a computer, or similar programmable device, can identify that a user has been present and presumably sitting during an interval of time. Reminders can therefore be provided at extended intervals of sitting. Further, it may be useful to know the user is present for the reminder.

The method may include demonstrating the rehabilitative exercises on a display screen, wherein the display screen is in communication with the programmable medium. The demonstration may include one or more figures explaining the exercise(s). The demonstration may include video or animation showing the exercise(s) in action. The demonstration may include music or some other type of audio to encourage performance of the exercise(s).

The method may include modifying rehabilitative exercises to be performed and/or a size of the intervals. The exercise(s) could be selected in advance from a library of possible exercises. The selection process may relate to which pre-existing ailments a user has or for which ailments the user is most at risk. The selection process may also be handled by the user and/or a remotely located physician or other caregiver. Similarly, the time intervals for the various exercises may be modified and may be configured based on a straight passage of time or cumulative time for which a user is actively operating the programmable device.

The method may include tracking interaction between the user and the computer while the rehabilitative exercises are supposed to be performed, thereby policing performance of the exercises. If a user is actively engaging a computer or other programmable device when the rehabilitative exercises are supposed to be performed, then the software may track that the exercise was not performed. An employer may keep this data. This data may also be utilized to reconfigure the next time interval before a rehabilitative exercise reminder.

While the invention as described herein has been focused to rehabilitative exercises, there may be other physical actions that can be produced and displayed under similar guidelines for these or other purposes, and such other actions are considered to be within the scope of the present invention. For example, instead of rehabilitation exercises, the system may provide stretching exercises which may be performed, e.g. at the user's desk.

Yet other possibilities are possible. For example, custom DVDs may be created, for example, as instruction cooking programs, woodworking programs, motor vehicle and home repair. Still other possibilities are to create customized tour programs, customized pet training programs and customized sport instructional programs, e.g. for teaching tennis, skiing, golf, etc.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. An exercise system, the system comprising:
a programmable device;
a first code stored on the programmable device, wherein the first code tracks time on the programmable device;
a second code stored on the programmable device, wherein the second code provides reminders to a user to perform exercises at intervals measured by the first code; and
a third code stored on the programmable device, wherein the third code tracks exercises performed.

2. The system of claim 1, further comprising a fourth code on the programmable device for tracking interaction between a user and the programmable device, wherein the second code provides reminders at intervals of activity as measured cooperatively between the first and fourth codes.

3. The system of claim 1, further comprising a fifth code for demonstrating the exercises on a display screen, wherein the display screen is in communication with the programmable device.

4. The system of claim 1, further comprising a sixth code operative through a user input for modifying one of the group comprising: exercises to be performed and a size of the intervals.

5. The system of claim 2, wherein the fourth code tracks interaction between the user and the programmable device when the exercises are supposed to be performed, thereby policing performance of the exercises.

6. A method of overseeing performance of rehabilitative exercises, the method comprising:
tracking time on a programmable device;
providing reminders to a user to perform exercises at intervals according to tracked time; and
tracking exercises performed.

7. The method of claim 6, further comprising tracking interaction between a user and the programmable device, wherein reminders are provided at intervals of activity as measured over time tracked.

8. The method of claim 6, further comprising demonstrating the exercises on a display screen, wherein the display screen is in communication with the programmable device.

9. The method of claim 6, further comprising modifying one of the group comprising: exercises to be performed and a size of the intervals.

10. The system of claim 7, further comprising tracking interaction between the user and the programmable device while the exercises are supposed to be performed, thereby policing performance of the exercises.

11. The system of claim 1, wherein the exercises comprise rehabilitation exercises.

12. The system of claim 1, wherein the exercises comprise stretching exercises.

13. A system used by a health care provider for creating a customized exercise program, the system comprising a computer having a computer readable program having plurality of exercise protocols;
an input device by which a health care provider may select one or more of said exercise protocols and associate patient details with said selected exercise program; and
a read-only output device for playing the customized exercise protocol.

14. A system of claim 13, wherein the practitioner may customize exercise perimeters from a selection stored in memory.

15. A system of claim 13, wherein the practitioner may write changes on a selected exercise protocol.

16. The method of claim 13, further comprising outputting the customized program onto machine readable media.

17. The method of claim 16, wherein the machine readable media comprises a DVD.

18. The system of claim 13, further comprising printing the customized exercise protocol on a tangible medium or transmitting the customized exercise protocol over the internet.
